(19) United States
(12) Patent Application Publication
(10) Pub. No.: US 2020/0412947 A1
(43) Pub. Date: Dec. 31, 2020

(54) Image Processing Device and Method Thereof

(71) Applicant: Augentix Inc., Hsinchu City (TW)

(72) Inventor: Hung-Chi Fang, Hsinchu City (TW)

(21) Appl. No.: 16/892,270

(22) Filed: Jun. 3, 2020

Related U.S. Application Data
(60) Provisional application No. 62/867,848, filed on Jun. 27, 2019.

(30) Foreign Application Priority Data
Mar. 2, 2020 (TW) 109106731

(51) Int. Cl. H04N 5/232; H04N 5/225

(52) U.S. Cl. CPC H04N 5/23238; H04N 5/23296; H04N 5/2256; H04N 5/2253; H04N 5/23299; H04N 5/2254

(57) ABSTRACT

An image processing device comprises an image sensing module, comprising a lens, configured to receive light; an image sensing unit, configured to receive the light through the lens to generate a raw image; and an image processing unit; wherein the image processing unit processes the raw image to generate a first image; the image processing unit obtains an interested region according to a predetermined algorithm and generates a second image according to the interested region from the raw image or the first image.

### CROSS REFERENCE TO RELATED APPLICATIONS

The present application claims the benefits of U.S. provisional application No. 62/867,848, filed on Jun. 27, 2019, and TW application No. 109106731, filed on Mar. 2, 2020, which are incorporated herein by reference.

### BACKGROUND OF THE INVENTION

### 1. Field of the Invention

The present invention relates to an image processing device and a method thereof, and more particularly, to an image processing device capable of simultaneously generating wide-angle images and zoom-in images with a single lens and a single image sensing module.

### 2. Description of the Prior Art

In the prior art, in order to obtain wide-angle images and zoom-in images, the prior art usually requires two sets of lenses and image sensing units to respectively generate the wide-angle images and the zoom-in images. For example, a current mobile phone often uses two lenses and two image sensing units to obtain both of the wide-angle images and the zoom-in images, wherein one of the lenses is a wide-angle lens to generate a wide-angle image, and the other is a zoom-in lens to generate a zoom-in image. However, this kind of design will cause complexity to the mechanical design, thus increasing the overall cost.

### SUMMARY OF THE INVENTION

A first embodiment of the present invention provides an image processing device, which comprises an image sensing module including a lens, an image sensing unit and an image processing unit; wherein the lens is configured to receive light, the image sensing unit is configured to receive the light through the lens to generate a raw image, the image processing unit processes the raw image to generate a first image, the image processing unit obtains an interested region according to a predetermined algorithm, and the image processing unit generates a second image from the raw image or the first image according to the interested region.

A second embodiment of the present invention provides an image processing device, which comprises a lens, an image sensing unit and an image processing unit; wherein the lens is configured to receive light, the image sensing unit is configured to receive the light through the lens to respectively generate a first raw image and a second raw image according to a first exposure time and a second exposure time, the image processing unit processes the first raw image to generate a first image, the image processing unit adjusts the first exposure time according to a brightness distribution value of a first predetermined region of the first raw image, the image processing unit obtains an interested region according to a predetermined algorithm, the image processing unit generates a second image from the second raw image according to the interested region, and the image processing unit adjusts the second exposure time according to a brightness distribution value of a second predetermined region of the interested region of the second raw image.

A third embodiment of the present invention provides an image processing method, which comprises generating a raw image by a lens and an image sensing unit; processing the raw image to generate a first image by an image processing unit; obtaining an interested region of the raw image or the first image by the image processing unit according to a predetermined algorithm; and generating a second image from the raw image by the image processing unit according to the interested region.

A fourth embodiment of the present invention discloses an image processing method, which comprises respectively generating a first raw image and a second raw image by a lens and an image sensing unit according to a first exposure time and a second exposure time; processing the first raw image to generate a first image by an image processing unit; obtaining an interested region of the second raw image by the image processing unit according to a predetermined algorithm; and generating a second image from the second raw image by the image processing unit according to the interested region; wherein the image processing unit adjusts the first exposure time according to a brightness distribution value of a first predetermined region of the first raw image and adjusts the second exposure time according to a brightness distribution value of a second predetermined region of the interested region of the second raw image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image processing device according to the first embodiment of the present invention.

FIG. 2 is a schematic diagram of an image processing device according to the second embodiment of the present invention.

### DETAILED DESCRIPTION

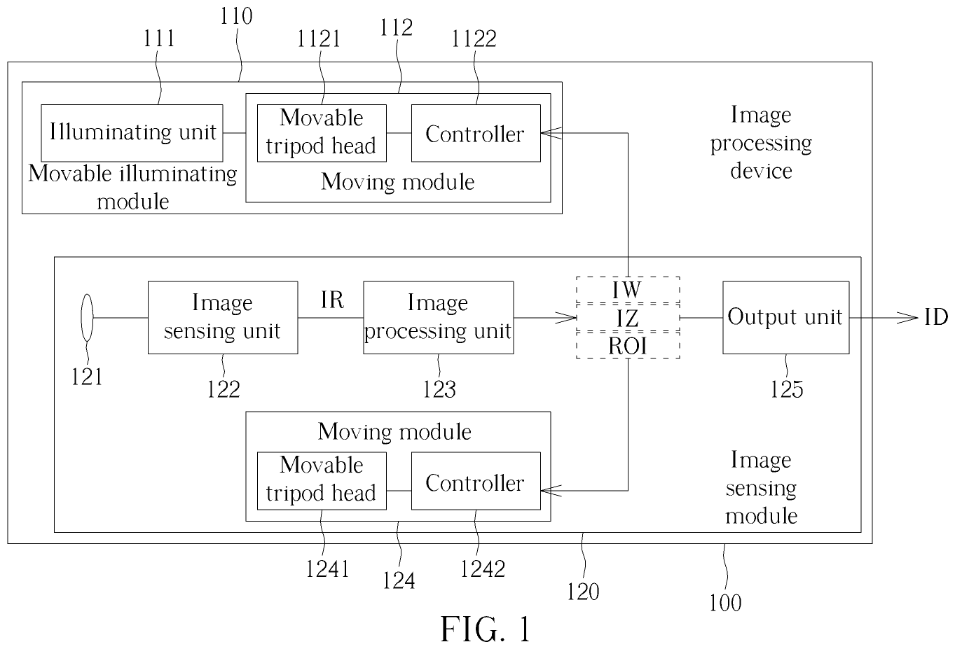

Please refer to FIG. 1. FIG. 1 is a schematic diagram of an image processing device 100 according to the first embodiment of the present invention. The image processing device 100 comprises a movable illuminating module 110 and an image sensing module 120. The movable illuminating module 110 comprises an illuminating unit 111 and a moving module 112. The moving module 112 comprises a movable tripod head 1121 and a controller 1122. The movable tripod head 1121 may be a tripod head, a pan head, a ball head, and so on. The movable tripod head 1121 moves or turns the illuminating unit 111 to illuminate a specific area X according to the controller 1122. The image sensing module 120 comprises a lens 121, an image sensing unit 122, and an image processing unit 123. The lens 121 may be a wide-angle lens. The image sensing unit 122 receives the light to generate a raw image IR through the lens 121.

The image processing unit 123 processes the raw image IR to generate a wide-angle image IW. According to a predetermined algorithm, an interested region (Region Of Interest, ROI) may be obtained from the raw image IR or the wide-angle image IW. For example, a predetermined region may be used to generate the interested region; or a region corresponding to one or more objects can also be used as the interested region, wherein the object fits to specific requirements. The specific requirements may be defined to that when a moving object is within an object size range, a moving velocity range, or a moving direction range, or when the moving object is determined to belong to a range of a predetermined category. The information of the interested region may be transmitted to the controller 1122 of the moving module 112 to obtain the specific area X, such that the movable tripod head 1121 may move or turn the illuminating unit 111 to illuminate the specific area X according to the controller 1122. In an embodiment, the specific area X may be the same as or similar to the interested region. Therefore, for example, if there is an interested object in a sensing range of the image sensing module 120, the image sensing module 120 may detect the object and generate an interested region accordingly. The location and the size of the interested region are transmitted to the movable illuminating module 110 to move or turn the illuminating position toward the interested object, thereby illuminating the interested object.

More specifically, the image processing unit 123 processes the raw image IR to generate a wide-angle image IW, and may obtain the interested region from the raw image IR or the wide-angle image IW according to the predetermined algorithm, wherein the interested region is the region where the object is located, and may also be the specific area X.

For example, when the predetermined algorithm is set to a moving velocity range, and an object moving velocity of which is within the moving velocity range, the image processing unit 123 may obtain the interested region from the raw image IR or the wide-angle image IW according to the predetermined algorithm, wherein the interested region is the region where the object is located. When the predetermined algorithm is set to an object size range, and a moving object size of which is within the object size range, the image processing unit 123 processes the raw image IR to generate a wide-angle image IW, and may obtain the interested region from the raw image IR or the wide-angle image IW according to the predetermined algorithm, wherein the interested region is the region where the object is located. Or, when the predetermined algorithm is set to a moving direction range, and an object moving direction of which is within the moving direction range, the image processing unit 123 may obtain the interested region from the raw image IR or the wide-angle image IW according to the predetermined algorithm, wherein the interested region of which is the region where the object is located. Or, when the predetermined algorithm is set to a range of a predetermined category, and an object of which is determined to belong to the range of the predetermined category (e.g., human/car/animal), the image processing unit 123 processes the raw image IR to generate a wide-angle image IW, and may obtain the interested region from the raw image IR or the wide-angle image IW according to the predetermined algorithm, wherein the interested region is the region where the object is located. Or, when the predetermined algorithm is set to an object tracking algorithm, motion vectors of a plurality of blocks may be obtained from the wide-angle image IW, wherein the blocks of which have a motion vector belonging to a range of a same direction can be grouped separately, and when a region size of a region connected by the grouped blocks is within a range, the location and the size of an interested object may be obtained as the interested region from the raw image IR or the wide-angle image IW.

After that, the information of the interested region may be transmitted to the controller 1122 of the moving module 112 to obtain the specific area X, such that the movable tripod head 1121 may move or turn the illuminating unit 111 to illuminate the specific area X according to the controller 1122.

In an embodiment, the image processing unit 123 further generates a zoom-in image IZ according to the interested region. The image processing unit 123 composites the wide-angle image IW and the zoom-in image IZ into a display image ID. The display image ID may be, for example, a concatenation of the wide-angle image IW and the zoom-in image IZ, or a sub-original image (the original image is a zoom-in image IZ and the sub-image is a wide-angle image IW, or vice versa.) Or, the display image ID is two images, one of the images is the wide-angle image IW, and the other image is the zoom-in image IZ. The display image ID may be displayed on a display device. In addition, the interested region may be plural. For example, there may exist a first interested region ROI 1 and a second interested region ROI 2 in the wide-angle image IW, meaning that there are two objects detected in the wide-angle image IW. Accordingly, the image processing unit 123 generates a first zoom-in image IZ1 and a second zoom-in image IZ2.

In the prior art, in order to obtain a wide-angle image and a zoom-in image, the image sensing module requires two independent sets of lenses and image sensing units to respectively obtain the wide-angle image IW and the zoom-in image IZ. In other words, in the prior art, the image sensing module requires a wide-angle lens and a corresponding image sensing unit to generate a wide-angle image, and also requires a zoom-in lens and a corresponding image sensing unit to generate the zoom-in image. Comparing with the prior art, in the present invention, the image processing unit 123 can use the wide-angle image IW of in the raw image IR generated by the wide-angle lens 121 and the image sensing unit 122 to generate the zoom-in image IZ. Therefore, the image sensing module 120 of the present invention only requires one set of lens and image sensing unit, thereby reducing the cost dramatically.

In another embodiment, the image sensing module 120 further comprises a moving module 124. The moving module 124 comprises a movable tripod head 1241 and a controller 1242. The movable tripod head 1241 moves or turns the lens 121 and the image sensing unit 122 according to the controller 1242. For example, the information of the interested region may be transmitted to the controller 1242 of the moving module 124, and then the movable tripod head 1241 moves or turns the lens 121 and the image sensing unit 122 accordingly. For example, when the interested region is leaving a view of the lens 121, the movable tripod head 1241 may move or turn the lens 121 and the image sensing unit 122 to keep the interested region within the view of the lens 121.

Furthermore, before compositing the wide-angle image IW and the zoom-in image IZ into the display image ID, the wide-angle image IW and the zoom-in image IZ will firstly execute a dewarp processing. During the dewarp processing, the wide-angle image IW and the zoom-in image IZ may be set to the same or different dewarp formula and parameters according to the user requirements. In addition, the wide-angle image IW may be generated at a first frame rate, and the zoom-in image IZ may be generated at a second frame rate, wherein the first frame rate and the second frame rate may be the same or different.

For example, when the predetermined algorithm is set to a predetermined velocity range, and an object moving velocity of which is within the predetermined velocity range, the image processing unit 123 processes the raw image IR to generate a wide-angle image IW and may obtain the interested region from the raw image IR or the wide-angle image IW according to the predetermined algorithm, wherein the interested region is the region where the object is located. The image processing unit 123 further generates a zoom-in image IZ according to the interested region. Or, when the predetermined algorithm is set to an object size range, and a moving object size of which is within the object size range, the image processing unit 123 processes the raw image IR to generate a wide-angle image IW and may obtain the interested region from the raw image IR or the wide-angle image IW according to the predetermined algorithm, wherein the interested region is the region where the object is located. The image processing unit 123 further generates a zoom-in image IZ according to the interested region. Or, when the predetermined algorithm is set to a moving direction range, and an object moving direction of which is within the moving direction range, the image processing unit 123 processes the raw image IR to generate a wide-angle image IW and may obtain the interested region from the raw image IR or the wide-angle image IW according to the predetermined algorithm, wherein the interested region is the region where the object is located. The image processing unit 123 further generates a zoom-in image IZ according to the interested region. Or, when the predetermined algorithm is set to a range of a predetermined category, and an object of which is determined to belong to the range of the predetermined category (e.g., human/car/animal), the image processing unit 123 processes the raw image IR to generate a wide-angle image IW, and may obtain the interested region from the raw image IR or the wide-angle image IW according to the predetermined algorithm, wherein the interested region is the region where the object is located. The image processing unit 123 further generates a zoom-in image IZ according to the interested region. Or, when the predetermined algorithm is set to an object tracking algorithm, motion vectors of a plurality of blocks may be obtained from the wide-angle image IW, wherein the blocks of which has a motion vector belonging to a range of a same direction can be grouped separately, and when a region size of a region connected by the grouped blocks is within a range, the location and the size of an interested object may be obtained as the interested region from the raw image IR or the wide-angle image IW.

From the above, the interested region often will be a moving object, it requires a higher frame rate, meaning that when the zoom-in image IZ is compressed, it will be compressed at the higher frame rate. However, the wide-angle image IW comprises more background portions, which are mostly static, so it can use a lower frame rate, meaning that when the wide-angle image is compressed, it will be compressed at the lower frame rate.

In addition, the image sensing module 120 further comprises an output unit 125. The output unit 125 compresses the display image ID to lower the transmission bit rate according to a predetermined algorithm. The predetermined algorithm may be, for example, H.264, H.265, etc. The compressed display image ID may be transmitted to a display device, and the display device decompresses and displays the display image ID.

Moreover, the image processing unit 123 controls an exposure time of the image sensing unit 122 according to the raw image IR. The exposure time of the image sensing unit 122 may be a predetermined value. More specifically, the image processing unit 123 adjusts the exposure time of the image sensing unit 122 according to a brightness distribution value of a predetermined region of the raw image IR. For example, when the brightness distribution value in a predetermined region in the raw image IR is too high, which represents that all scope of the raw image IR is too bright, the image processing unit 123 will lowers the exposure time of the image sensing unit 122; when the brightness distribution value of a predetermined region of the raw image IR is too low, which represents that all scope of the raw image IR is too dark, the image processing unit 123 will raises the exposure time of the image sensing unit 122. However, this kind of the method, considering that the exposure time is adjusted according to all view scope of the raw image IR, it may further causes the image of interested region is too bright or too dark. For example, when the brightness distribution value of a predetermined region of the raw image IR is higher, but the brightness distribution value of a predetermined region of the image of interested region of the raw image IR is lower, it represents that the background of in the raw image IR is brighter, but the image of interested region is darker. At this time, the image processing unit 123 will lowers the exposure time of the image sensing unit 122, therefore the background of the raw image IR will conform to a predetermined brightness, but that will cause the image of interested region is too dark. On the contrast, when the brightness distribution value of a predetermined region of the raw image IR is lower, but the brightness distribution value of a predetermined region of the image of interested region of the raw image IR is higher, it represents that the background of in the raw image IR is darker, but the image of interested region is brighter. At this time, the image processing unit 123 will raises the exposure time of the image sensing unit 122, therefore the background of in the raw image IR will conform to a predetermined brightness, but that will cause the image of interested region is too bright. Therefore, the present invention provides a method of providing with different exposure times for the raw image IR and the image of interested region, which is respectively controlled by the brightness distribution value of a predetermined region image of the raw image IR and the brightness distribution value of a predetermined region of the image of interested region, therefore the brightness of the raw image IR and the brightness of the image of interested region will conform to the predetermined brightness. For example, the image processing unit 123 may control the exposure time of the image sensing unit 122 to generate (N+X)-th wide-angle image IW according to a predetermined region of the previous N raw images IR; meanwhile, the image processing unit 123 may control the exposure times of the image sensing unit 122 to generate (M+Y)-th zoom-in image IZ according to a predetermined region of the interested region of previous M raw images IR. For example, when N=M, X=1, and Y=2, the exposure time of the image sensing unit 122 corresponding to the raw image IR(N+1) is T(N+1); the exposure time of the image sensing unit 122 corresponding to the raw image IR(N+2) is T(N+2); wherein the exposure time T(N+1) is adjusted according to the brightness distribution values of a predetermined region of the previous N raw images IR; the exposure time T(N+2) is adjusted according to the brightness distribution values of a predetermined region of the interested region of previous N raw images IR. Therefore, the image sensing unit 122 may obtain the wide-angle image IW(N+1) conformed to the predetermined brightness, and the zoom-in image IZ(N+2) conformed to the predetermined brightness.

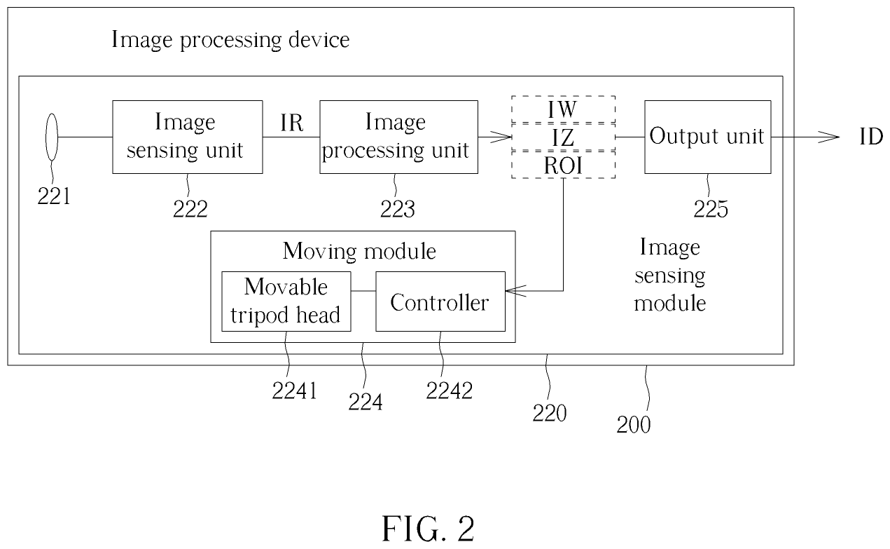

Please refer to FIG. 2. FIG. 2 is a schematic diagram of an image processing device 200 according to the second embodiment of the present invention. The image processing device 200 comprises an image sensing module 220. The image sensing module 220 comprises a lens 221, an image sensing unit 222, and an image processing unit 223. The lens 221 may be a wide-angle lens. The image sensing unit 222 uses the lens 221 to receive the light to generate a raw image IR. The image processing unit 223 processes the raw image IR to generate a wide-angle image IW. An interested region (Region Of Interest, ROI) may be obtained from the raw image IR or the wide-angle image IW according to a predetermined algorithm.

For example, a predetermined region may be used to generate the interested region; or a region corresponding to one or more objects can also be used as the interested region, wherein the object fits to specific requirements. The specific requirements may be an object moving velocity of which being within a moving velocity range, an object moving direction of which being within a moving direction range, or an object of which being determined to be within a range of a predetermined category.

In an embodiment, the image processing unit 223 further generates a zoom-in image IZ from the wide-angle image IW according to the interested region. The image processing unit 223 composites the wide-angle image IW and the zoom-in image IZ into a display image ID. The display image ID may be, for example, a concatenation of the wide-angle image IW and the zoom-in image IZ or a sub-original image (the original image is a zoom-in image IZ and the sub-original image is a wide-angle image IW, or vice versa.). Or, the display image ID is two images, one is the wide-angle image IW, and the other one is the zoom-in image IZ. The display image ID may be displayed on a display device. In addition, the interested region may be plural. For example, there may exist a first interested region ROI 1 and a second interested region ROI 2 in the wide-angle image IW, meaning that there are two objects detected in the wide-angle image IW. Accordingly, the image processing unit 223 generates a first zoom-in image IZ1 and a second zoom-in image IZ2 from the raw image IR.

In the prior art, in order to obtain a wide-angle image and a zoom-in image, the image sensing module requires two sets of independent lenses and image sensing units to respectively obtain the wide-angle image IW and the zoom-in image IZ. In other words, in the prior art, the image sensing module requires a wide-angle lens and a corresponding image sensing unit to generate a wide-angle image, and also requires a zoom-in lens and a corresponding image sensing unit to generate the zoom-in image. Comparing the present invention with the prior art, the image processing unit 223 can use the wide-angle image IW of in the raw image IR generated by the wide-angle lens 221 and the image sensing unit 222 to generate the zoom-in image IZ. Therefore, the image sensing module 220 of the present invention only requires one set of lens and image sensing unit, thereby reducing the cost dramatically.

In another embodiment, the image sensing module 220 further comprises a moving module 224. The moving module 224 comprises a movable tripod head 2241 and a controller 2242. The movable tripod head 2241 moves or turns the lens 221 and the image sensing unit 222 according to the controller 2242. For example, the information of the interested region may be transmitted to the controller 2242 of the moving module 224, and then the movable tripod head 2241 moves or turns the lens 221 and the image sensing unit 222 accordingly. For example, when the interested region is leaving a view of the lens 221, the movable tripod head 2241 may move or turn the lens 221 and the image sensing unit 222 to keep the interested region within the view of the lens 221.

Furthermore, before compositing the wide-angle image IW and the zoom-in image IZ into the display image ID, the wide-angle image IW and the zoom-in image IZ will firstly execute a dewarp processing. During the dewarp processing, the wide-angle image IW and the zoom-in image IZ may be set to the same or different dewarp formula and parameters according to the user requirements. In addition, the wide-angle image IW may be generated at a first frame rate, and the zoom-in image IZ may be generated at a second frame rate, wherein the first frame rate and the second frame rate may be the same or different.

For example, when the predetermined algorithm is set to a predetermined velocity range, and an object moving velocity of which is within the predetermined velocity range, the image processing unit 223 processes the raw image IR to generate a wide-angle image IW and may obtain the interested region from the raw image IR or the wide-angle image IW according to the predetermined algorithm, wherein the interested region is the region where the object is located. The image processing unit 223 further generates a zoom-in image IZ according to the interested region. Or, when the predetermined algorithm is set to an object size range, and a moving object size of which is within the object size range, the image processing unit 223 processes the raw image IR to generate a wide-angle image IW and may obtain the interested region from the raw image IR or the wide-angle image IW according to the predetermined algorithm, wherein the interested region is the region where the object is located. The image processing unit 223 further generates a zoom-in image IZ according to the interested region. Or, when the predetermined algorithm is set to a moving direction range, and an object moving direction of which is within the moving direction range, the image processing unit 223 processes the raw image IR to generate a wide-angle image IW and may obtain the interested region from the raw image IR or the wide-angle image IW according to the predetermined algorithm, wherein the interested region is the region where the object is located. The image processing unit 223 further generates a zoom-in image IZ according to the interested region. Or, when the predetermined algorithm is set to a range of a predetermined category, and an object of which is determined to belong to the range of the predetermined category (e.g., human/car/animal), the image processing unit 223 processes the raw image IR to generate a wide-angle image IW, and may obtain the interested region from the raw image IR or the wide-angle image IW according to the predetermined algorithm, wherein the interested region is the region where the object is located. The image processing unit 223 further generates a zoom-in image IZ according to the interested region. Or, when the predetermined algorithm is set to an object tracking algorithm, motion vectors of a plurality of blocks may be obtained from the wide-angle image IW, wherein the blocks of which has a motion vector belonging to a range of a same direction can be grouped separately, and when a region size of a region connected by the grouped blocks is within a range, the location and the size of an interested object may be obtained as the interested region from the raw image IR or the wide-angle image IW.

From the above, the interested region often will be a moving object, it requires a higher frame rate, meaning that when the zoom-in image IZ is compressed, it will be compressed at the higher frame rate. However, the wide-angle image IW comprises more background portions, which are mostly static, so it can use a lower frame rate, meaning that when the wide-angle image is compressed, it will be compressed at the lower frame rate.

In addition, the image sensing module 220 further comprises an output unit 225. The output unit 225 compresses the display image ID to lower the transmission bit rate according to a predetermined algorithm. The predetermined algorithm may be, for example, H.264, H.265, etc. The compressed display image ID may be transmitted to a display device, and the display device decompresses and displays the display image ID.

Moreover, the image processing unit 223 controls an exposure time of the image sensing unit 222 according to the raw image IR. The exposure time of the image sensing unit 222 may be a predetermined value. More specifically, the image processing unit 223 adjusts the exposure time of the image sensing unit 222 according to a brightness distribution value of a predetermined region of the raw image IR. For example, when the brightness distribution value of a predetermined region of the raw image IR is too high, which represents that all scope of the raw image IR is too bright, the image processing unit 223 will lowers the exposure time of the image sensing unit 222; when the brightness distribution value of a predetermined region of the raw image IR is too low, which represents that all scope of the raw image IR is too dark, the image processing unit 223 rises the exposure time of the image sensing unit 222. However, this kind of the method, considering that the exposure time is adjusted according to all view scope of the raw image, it may further causes the image of interested region is too bright or too dark. For example, when the brightness distribution value of a predetermined region of the raw image IR is higher, but the brightness distribution value of a predetermined region of the image of interested region of the raw image IR is lower, it represents that the background of the raw image IR is brighter, but the interested region is darker. In such a situation, the image processing unit 223 will lowers the exposure time of the image sensing unit 222, therefore the background of the raw image IR will conform to a predetermined brightness, but that will cause the interested region is too dark. On the contrast, when the brightness distribution value of a predetermined region of the raw image IR is lower, but the brightness distribution value of a predetermined region of the image of interested region of the raw image IR is higher, it represents that the background of the raw image IR is darker, but the interested region is brighter. At this time, the image processing unit 223 will rises the exposure time of the image sensing unit 222, therefore the background of the raw image IR will conform to a predetermined brightness, but that will cause the image of interested region is too bright. Therefore, the present invention provides a method of providing with different exposure times for the raw image IR and the image of interested region, which is respectively controlled by the brightness distribution value of a predetermined region image of the raw image IR and the brightness distribution value of a predetermined region of the image of interested region, therefore the brightness of the raw image IR and the brightness of the image of interested region will conform to the predetermined brightness. For example, the image processing unit 223 may control the exposure time of the image sensing unit 222 to generate the (N+X)-th wide-angle image IW according to a predetermined region of the previous N raw images IR; meanwhile, the image processing unit 223 may control the exposure times of the image sensing unit 222 to generate the (M+Y)-th zoom-in image IZ according to a predetermined region of the interested region of previous M raw images IR. For example, when N=M, X=1, and Y=2, the exposure time of the image sensing unit 222 corresponding to the raw image IR(N+1) is T(N+1); the exposure time of the image sensing unit 222 corresponding to the raw image IR(N+2) is T(N+2); wherein the exposure time T(N+1) is adjusted according to the brightness distribution values of a predetermined region of the previous N raw images IR; the exposure time T(N+2) is adjusted according to the brightness distribution values of a predetermined region of the interested region of previous N raw images IR. Therefore, the image sensing unit 222 may obtain the wide-angle image IW(N+1) conformed to the predetermined brightness, and the zoom-in image IZ(N+2) conformed to the predetermined brightness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing device, comprising:
an image sensing module including a lens, an image sensing unit and an image processing unit;
wherein the lens is configured to receive light, the image sensing unit is configured to receive the light through the lens to generate a raw image; and
wherein the image processing unit processes the raw image to generate a first image; the image processing unit obtains an interested region according to a predetermined algorithm and generates a second image from the raw image or the first image according to the interested region.

2. The image processing device of claim 1, wherein the lens is a wide-angle lens, the first image is a wide-angle image; the second image is a zoom-in image; the wide-angle image is generated at a first frame rate; the zoom-in image is generated at a second frame rate; the first frame rate is smaller than the second frame rate.

3. The image processing device of claim 1, wherein when the predetermined algorithm is set to a moving velocity range, and a moving velocity of an interested object is within the moving velocity range, the interested region is obtained by a location information of the interested object; when the predetermined algorithm is set to an object size range, and a size of an interested object is within the object size range, the interested region is obtained by the location information of the interested object; when the predetermined algorithm is set to a moving direction range, and a moving direction of an interested object is within the moving direction range, the interested region is obtained by the location information of the interested object; when the predetermined algorithm is set to a range of a predetermined category, and an interested object belongs to the range of the predetermined category, the interested region is obtained by the location information of the interested object; when the predetermined algorithm is set to an object tracking algorithm, motion vectors of a plurality of blocks are obtained from the first image, wherein the blocks of which has a motion vector belonging to a range of a same direction can be grouped, and when a region size of a region connected by the grouped blocks is within a range, a location and a size of an interested object is obtained as the interested region.

4. The image processing device of claim 1, wherein the image sensing module further comprises:
a moving module including a movable tripod head and a controller;
wherein the controller is configured to receive information of the interested region;
wherein the controller controls the movable tripod head to moves or turns the lens and the image sensing unit according to the information of the interested region.

5. The image processing device of claim 1, further comprising:
a movable illuminating module including an illuminating unit and a moving module having a movable tripod head and a controller;
wherein the controller is configured to receive the information of the interested region;
wherein the controller controls the movable tripod head to moves or turns the lens and the illuminating unit according to the information of the interested region.

6. An image processing device, comprising:
a lens, configured to receive light;
an image sensing unit, configured to receive the light through the lens to respectively generate a first raw image and a second raw image according to a first exposure time and a second exposure time; and
an image processing unit;
wherein the image processing unit processes the first raw image to generate a first image, the image processing unit adjusts the first exposure time according to a brightness distribution value of a first predetermined region of the first raw image; the image processing unit obtains an interested region according to a predetermined algorithm, the image processing unit generates a second image from the second raw image according to the interested region, the image processing unit adjusts the second exposure time according to a brightness distribution value of a second predetermined region of the interested region of the second raw image.

7. The image processing device of claim 6, wherein the lens is a wide-angle lens, the first image is a wide-angle image; the second image is a zoom-in image; the wide-angle image is generated at a first frame rate; the zoom-in image at generated in a second frame rate; the first frame rate is smaller than the second frame rate.

8. The image processing device of claim 6, wherein when the predetermined algorithm is set to a moving velocity range, and a moving velocity of an interested object is within the moving velocity range, the interested region is obtained by a location information of the interested object; when the predetermined algorithm is set to an object size range, and a size of an interested object is within the object size range, the interested region is obtained by the location information of the interested object; when the predetermined algorithm is set to a moving direction range, and a moving direction of an interested object is within the moving direction range, the interested region is obtained by the location information of the interested object; when the predetermined algorithm is set to a range of a predetermined category, and an interested object belongs to the range of the predetermined category, the interested region is obtained by the location information of the interested object; when the predetermined algorithm is set to an object tracking algorithm, motion vectors of a plurality of blocks are obtained from the first image, wherein the blocks which has a motion vector belonging to a range of a same direction can be grouped, and when a region size of a region connected by the grouped blocks is within a range, a location and a size of an interested object is obtained as the interested region.

9. The image processing device of claim 6, wherein the image sensing module further comprises:
a moving module including a movable tripod head and a controller;
wherein the controller, configured to receive information of the interested region;
wherein the controller controls the movable tripod head to moves or turns the lens and the image sensing unit according to the information of the interested region.

10. The image processing device of claim 6, further comprising:
a movable illuminating module including an illuminating unit and a moving module having a movable tripod head and a controller;
wherein the controller is configured to receive the information of the interested region;
wherein the controller controls the movable tripod head to moves or turns the lens and the illuminating unit according to the information of the interested region.

11. An image processing method, comprising:
generating a raw image by a lens and an image sensing unit;
processing the raw image to generate a first image by an image processing unit;
obtaining an interested region of the raw image or the first image by the image processing unit according to a predetermined algorithm; and
generating a second image from the raw image by the image processing unit according to the interested region.

12. The image processing method of claim 11, wherein the lens is a wide-angle lens, the first image is a wide-angle image; the second image is a zoom-in image; the wide-angle image is generated at a first frame rate; the zoom-in image is generated at a second frame rate; the first frame rate is smaller than the second frame rate.

13. The image processing method of claim 11, wherein when the predetermined algorithm is set to a moving velocity range, and a moving velocity of an interested object is within the moving velocity range, the interested region is obtained by a location information of the interested object; when the predetermined algorithm is set to an object size range, and a size of an interested object is within the object size range, the interested region is obtained by the location information of the interested object; when the predetermined algorithm is set to a moving direction range, and a moving direction of an interested object is within the moving direction range, the interested region is obtained by the location information of the interested object; when the predetermined algorithm is set to a range of a predetermined category, and an interested object is within the range of the predetermined category, the interested region is obtained by the location information of the interested object; when the predetermined algorithm is set to an object tracking algorithm, motion vectors of a plurality of blocks are obtained from the first image, wherein the blocks which has a motion vector belonging to a range of a same direction can be grouped, and when a region size of a region connected by the grouped blocks is within a range, a location and a size of an interested object is obtained as the interested region.

14. The image processing method of claim 11, comprising:
moving or turning the lens and the image sensing unit by a moving module according to an information of the interested region;
wherein the moving module comprises a movable tripod head and a controller; the controller controls the movable tripod head to moves or turns the lens and the image sensing unit according to the information of the interested region.

15. The image processing method of claim 11, comprising:
moving or turning a movable illuminating module by the movable illuminating module according an information of the interested region;
wherein the movable illuminating module comprises a movable tripod head, an illuminating unit, and a controller; the controller controls the movable tripod head to moves or turns the lens and the illuminating unit according to the information of the interested region.

16. An image processing method, comprising:
respectively generating a first raw image and a second raw image by a lens and an image sensing unit according to a first exposure time and a second exposure time;
processing the first raw image to generate a first image by an image processing unit;
obtaining an interested region of the second raw image by the image processing unit according to a predetermined algorithm; and
generating a second image from the second raw image by the image processing unit according to the interested region;
wherein the image processing unit adjusts the first exposure time according to a brightness distribution value of a first predetermined region of the first raw image, the image processing unit adjusts the second exposure time according to a brightness distribution value of a second predetermined region of the interested region of the second raw image.

17. The image processing method of claim 16, wherein the lens is a wide-angle lens, the first image is a wide-angle image; the second image is a zoom-in image; the wide-angle image is generated at a first frame rate; the zoom-in image is generated at a second frame rate; the first frame rate is less than the second frame rate.

18. The image processing method of claim 16, wherein when the predetermined algorithm is set to a moving velocity range, and a moving velocity of an interested object is within the moving velocity range, the interested region is obtained by a location information of the interested object; when the predetermined algorithm is set to an object size range, and a size of an interested object is within the object size range, the interested region is obtained by the location information of the interested object; when the predetermined algorithm is set to a moving direction range, and a moving direction of an interested object is within the moving direction range, the interested region is obtained by the location information of the interested object; when the predetermined algorithm is set to a range of a predetermined category, and an interested object is within the range of the predetermined category, the interested region is obtained by the location information of the interested object; when the predetermined algorithm is set to an object tracking algorithm, motion vectors of a plurality of blocks are obtained from the first image, wherein the blocks which has a motion vector belonging to a range of a same direction can be grouped, and when a region size of a region connected by the grouped blocks is within a range, a location and a size of an interested object is obtained as the interested region.

19. The image processing method of claim 16, comprising:
moving or turning the lens and the image sensing unit by a moving module according to an information of the interested region;
wherein the moving module comprises a movable tripod head and a controller; the controller controls the movable tripod head to moves or turns the lens and the image sensing unit according to the information of the interested region.

20. The image processing method of claim 16, comprising:
moving or turning a movable illuminating module by the movable illuminating module according an information of the interested region;
wherein the movable illuminating module comprises a movable tripod head, an illuminating unit, and a controller; the controller controls the movable tripod head to moves or turns the lens and the illuminating unit according to the information of the interested region.
